(19) United States
(12) Patent Application Publication
(10) Pub. No.: US 2013/0252484 A1
(43) Pub. Date: Sep. 26, 2013

(54) CONNECTING STRUCTURE FOR ELECTRONIC DEVICES

(71) Applicant: YAZAKI CORPORATION, Tokyo (JP)

(72) Inventor: Shinji MOCHIZUKI, Shizuoka (JP)

(73) Assignee: YAZAKI CORPORATION, Tokyo (JP)

(21) Appl. No.: 13/895,092

(22) Filed: May 15, 2013

Related U.S. Application Data
(63) Continuation of application No. PCT/JP2011/077280, filed on Nov. 18, 2011.

(30) Foreign Application Priority Data
Nov. 18, 2010 (JP) 2010-258230

(51) Int. Cl. H01R 13/20

(52) U.S. Cl. CPC H01R 13/20
USPC 439/786

(57) ABSTRACT

A terminal in a connecting structure for electronic devices includes a first contact part provided at one portion of the terminal, a second contact part provided at the other end portion of the terminal, and a third contact part, provided between the first contact part and the second contact part. The first contact part has a main contact piece configured to come in resilient contact with a contact of a first electronic device. The second contact part configured to come in press contact with an electric wire. The third contact part has a pair of auxiliary contact pieces configured to respectively come in press contact with a pair of contacts of a second electronic device. A connecting portion which connects the pair of the auxiliary contact pieces each other is formed in the third contact part in a separatable manner.

### BACKGROUND

The present invention is related to a connecting structure of electronic devices which can connect electronic devices having different pitches between contacts.

Patent Document 1 discloses a connecting structure of electronic devices that assuredly electrically connects the electronic devices to obtain a high reliability. As shown in FIG. 17, in the connecting structure of the electronic devices, one pair of busbars 501 and 503 are attached to a housing and a semiconductor light emitting element (LED) 505 as a light source is also attached to the housing. The busbars 501 and 503 that are formed in the shapes of flat plates and are divided into two include an electric wire connecting part 507, a Zener diode connecting part 509, a resistor connecting part 511 and an LED connecting part 513. In the resistor connecting part 511, press contact blades 515 and 515 are provided respectively in the busbars 501 and 503 that are divided into two. In the Zener diode connecting part 509, a single press contact blade 517 is provided in the one busbar 501 and a single press contact blade 519 is provided in the other busbar 503.

In a Zener diode 521, one lead part 523 is electrically connected to the one busbar 501 and the other lead part 525 is electrically connected to the other busbar 503 respectively, so that the Zener diode 521 is connected in parallel with the one pair of busbars 501 and 503 in the downstream side of a resistor 527. Thus, the Zener diode functions to protect the LED from a damage due to a sudden large voltage applied to a circuit by a static electricity in the direction where a forward electromotive force is supplied to the diode and to prevent a current from being supplied in the direction where a counter electromotive force is supplied to the diode and similarly protect the LED from the damage.

[Patent Document 1] JP-A-2007-149762

### SUMMARY

However, in the related connecting structure of the electronic devices, the two kinds of busbars 501 and 503 are necessary in which connecting parts of different dimensions are formed so as to meet the forms and sizes of the electronic devices. Here, the connecting parts correspond to including the press contact blades 515, 515, the press contact blade 517, and the press contact blade 519. Further, a problem arises that only the electronic devices for through holes having the lead parts such as the Zener diode 521 and the resistor 527 can be mounted and electronic devices to be mounted on a surface that are recently increasingly required and inexpensive cannot be connected. In addition thereto, in order to allow a connecting structure to meet the presence or absence of specific electronic devices, a resistor for example, are necessary two kinds of terminals. That is, a terminal required when the resistor is mounted and a terminal required when the resistor is not mounted are necessary.

It is therefore one advantageous aspect of the present invention to provide a connecting structure for electronic devices that can connect electronic devices to be mounted on a surface which have different pitches between contacts by using one kind of terminal and can use one kind of terminal irrespective of the presence or absence of the electronic devices.

According to one advantage of the invention, there is provided a connecting structure for electronic devices, the connecting structure comprising:

a terminal, including:
a first contact part, provided at one end portion of the terminal, and having a main contact piece, the main contact piece being configured to come in resilient contact with a contact of a first electronic device;
a second contact part, provided at the other end portion of the terminal, and configured to come in press contact with an electric wire; and
a third contact part, provided between the first contact part and the second contact part, having a pair of auxiliary contact pieces configured to respectively come in press contact with a pair of contacts of a second electronic device, and formed with a connecting portion which connects the pair of the auxiliary contact pieces each other in a separatable manner.

The connecting structure may comprise a pair of the terminals, and may be configured such that one of the terminal is connected to an anode, the other of the terminal is connected to a cathode, and the connecting portion is separated thereby the pair of the auxiliary contact pieces are series-connected with each other through the second electronic device.

The connecting structure may be configured such that in a state where the terminal is inserted into a housing, the connecting portion is disposed on a surface of the terminal facing in a direction opposite to an inserting direction of the terminal.

The connecting structure may be configured such that the pair of contacts of the second electronic device are provided on a same surface of the second electronic device.

### BRIEF DESCRIPTION OF DRAWINGS

FIG. 1 is a perspective view of two terminals used in a connecting structure of electronic devices according to an embodiment of the present invention.

FIG. 2 is a perspective view of a housing that accommodates the terminals shown in FIG. 1.

FIG. 3 is a perspective view of the terminal shown in FIG. 1.

FIG. 4A is a plan view of the terminal shown in FIG. 3.

FIG. 4B is a sectional view of the terminal seen from a line A-A in FIG. 4A.

FIG. 4C is a sectional view of the terminal seen from a line B-B in FIG. 4A.

FIG. 5A is a perspective view of a semiconductor light emitting element used in the terminals shown in FIG. 1.

FIG. 5B is a perspective view of a Zener diode used in the terminals shown in FIG. 1.

FIG. 6 is a circuit diagram in the connecting structure shown in FIG. 1.

FIG. 7A is a perspective view of the terminal having a connecting part separated.

FIG. 7B is a perspective view in which an upper part and a lower part of FIG. 7A are inverted.

FIG. 8 is a development view of the terminal.

FIG. 9 is an attaching process diagram of the terminal.

FIG. 10 is a cutting process diagram of a connecting part.

FIG. 11 is an attaching process diagram of electronic devices.

FIG. 12 is an attaching process diagram of a resistor.

FIG. 13 is an attaching process diagram of the housing.

FIG. 14 is an attaching process diagram of an electric wire holder.

FIG. 15 is a perspective view of an LED unit.

FIG. 16A is a plan view of the LED unit.

FIG. 16B is a sectional view seen of the LED unit from a line C-C in FIG. 16A.

FIG. 16C is a sectional view of the LED unit seen from a line D-D in FIG. 16A.

FIG. 17 is a perspective view of a related connecting structure of electronic devices.

### DETAILED DESCRIPTION OF EXEMPLIFIED EMBODIMENTS

An embodiment of the present invention will be described below by referring to the drawings.

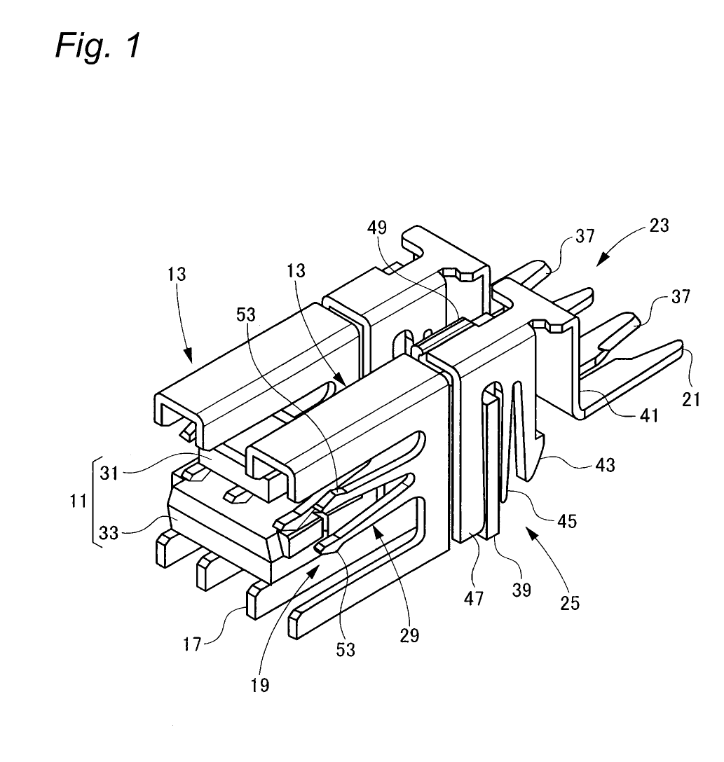

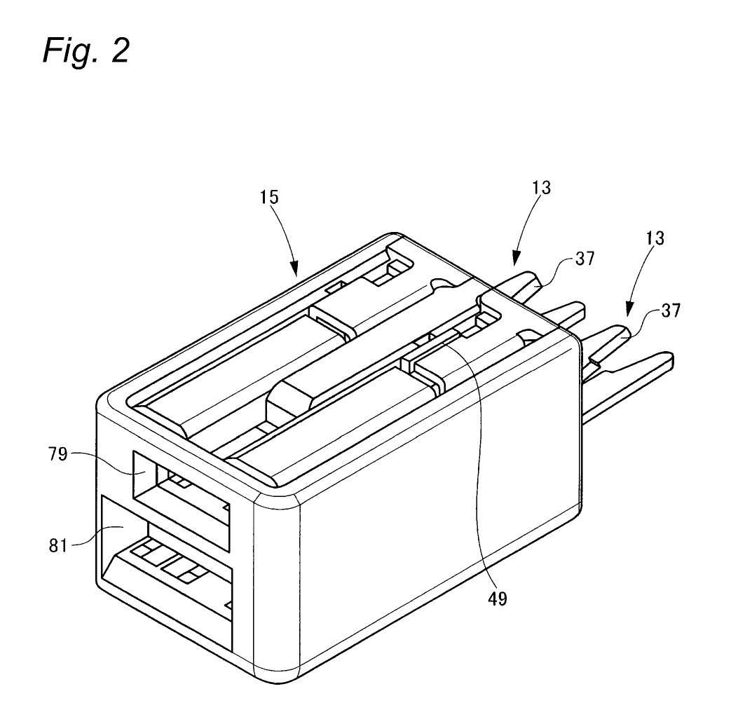

FIG. 1 is a perspective view of two terminals used in a connecting structure of electronic devices according to the present invention. FIG. 2 is a perspective view of a housing that accommodates the terminals shown in FIG. 1.

A connecting structure for electronic devices 11 according to the present embodiment has two terminals 13 of the same form shown in FIG. 1 as main parts of the structure. The two terminals 13 are accommodated in a housing 15 shown in FIG. 2 and used.

Each of the two terminals 13 includes a first press contact part 19 in one end 17, a second press contact part 23 in the other end 21 and a third press contact part 25 in an intermediate part between the first press contact part 19 and the second press contact part 23. The two terminals 13 are spaced from each other and arranged in parallel. In the first press contact part 19, at least one pair of main contact spring pieces 29 which can respectively come into resilient contact with pairs of contact parts 27 of two electronic devices 11 are arranged and opposed to each other. In the present embodiment, in one terminal 13, one pair of main contact spring pieces 29 are provided. Between the two terminals, the one pair of adjacent main contact spring pieces 29 are connected to one pair of contact parts of a semiconductor light emitting element 31 as a first one of the electronic devices 11. Further, the other pair of main contact spring pieces 29 located between the two terminals are connected to one pair of contact parts of a Zener diode 33 as a second one of the electronic devices 11.

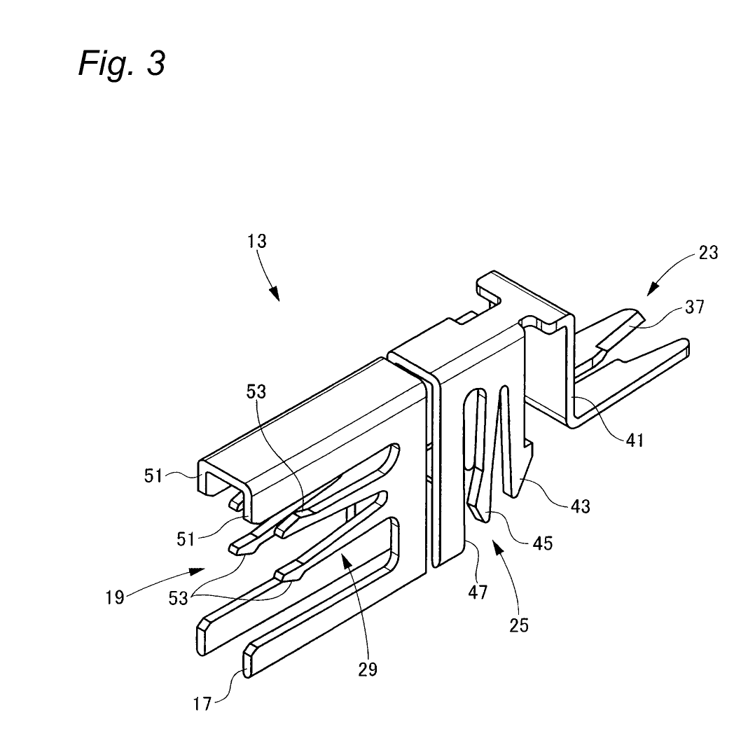

FIG. 3 is a perspective view of the one terminal 13 shown in FIG. 1.

A part of the terminal 13 protrudes to an external part of a housing 15 under a state that the terminal is attached to the housing 15. In the present embodiment, a side to which a part of the terminal 13 protrudes from the housing 15 is referred to as a “rear” and an opposite side thereto is referred to as a “front”. A rear end of the terminal 13 forms the above-described second press contact part 23. In the second press contact part 23, press contact blades 37 are provided that cut and tear a coating of a coated electric wire 35 to come into electric contact with a conductor.

In a front part of the press contact blades 37, the third press contact part 25 is provided. Namely, in the intermediate part between the first press contact part 19 and the second press contact part 23, the third press contact part 25 is provided. The third press contact part 25 can come into press contact with other electronic devices 11, for instance, a resistor 39 shown in FIG. 1. In the third press contact part 25, a rear part abutting piece 41, a rear part resilient leg 43, an auxiliary contact spring piece 45 and a front part abutting piece 47 are connected forward from the press contact blades 37.

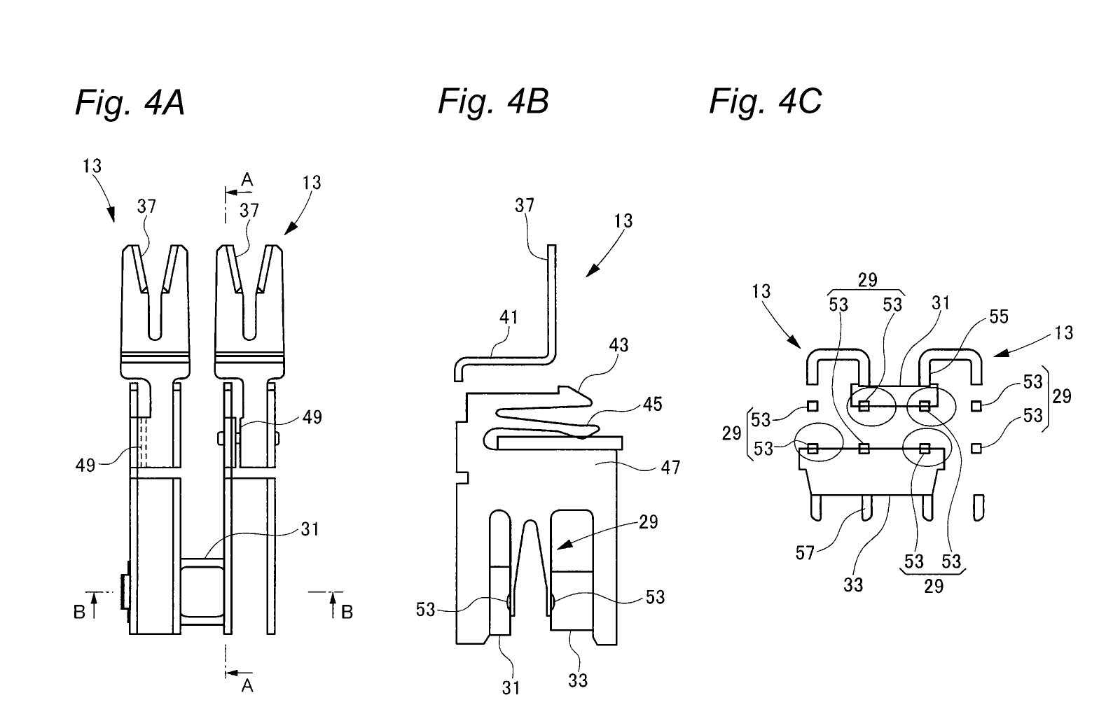

To the front part abutting piece 47 of a back surface side in FIG. 3, the first press contact part 19 as one end 17 (a front end) of the terminal 13 is connected through a connecting portion 49 (see FIG. 4). The press contact blade 37, the rear part abutting piece 41, the rear part resilient leg 43, the auxiliary contact spring piece 45, the front part abutting piece 47 and the first press contact part 19 are integrally stamped by a thin plate working, and then, bent to a form shown in FIG. 3. The first press contact part 19 of the terminal 13 is bent in the shape of U so that a pair of side walls 51 are parallel to each other, and the main contact spring pieces 29 are stamped and formed respectively in the side walls 51. A main body of the terminal 13 is bent and formed in the shape of U and the main contact spring pieces 29 are formed in the one pair of opposed side walls 51 by a stamping work. Thus, a resiliently connecting structure having many electric contact parts 53 can be easily and compactly manufactured.

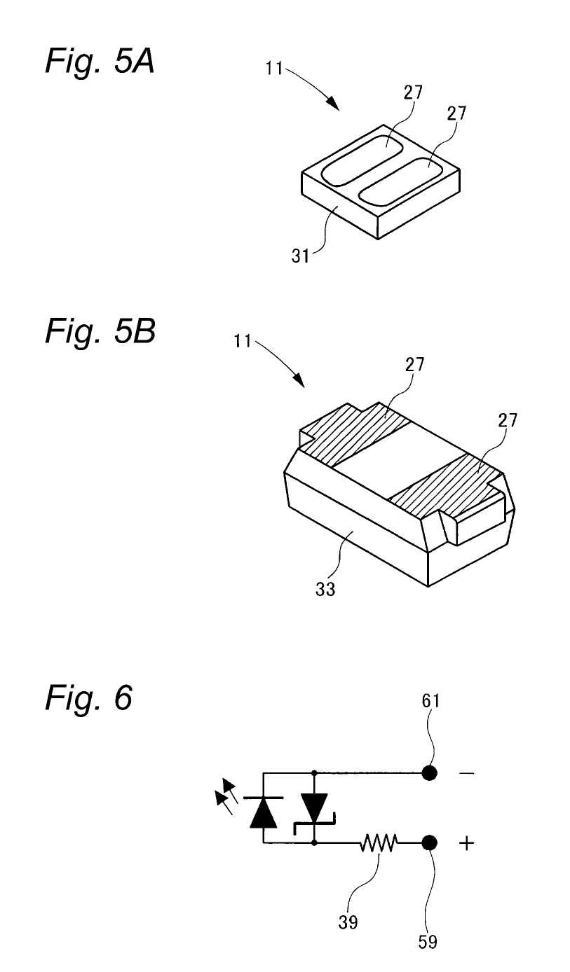

FIG. 4A is a plan view of the terminal 13 shown in FIG. 3, FIG. 4B is a view seen from a line A-A thereof, and FIG. 4C is a view seen from a line B-B thereof. FIG. 5A is a perspective view of the semiconductor light emitting element 31 and FIG. 5B is a perspective view of the Zener diode 33.

In the one terminal 13, one pair of main contact spring pieces 29 are formed in parallel and ends which branch substantially in the shape of Y form the electric contact parts 53. The electric contact parts 53 are formed in triangular shapes having contacts as apex angles. As shown in FIG. 4A, the two terminals 13 are spaced from each other and arranged in parallel. Thus, as shown in FIG. 4C, the electric contact parts 53 are arranged at eight positions including four positions in each of sides. To the electric contact parts 53 at the four positions of an upper one side, upper seat parts 55 respectively formed in the terminals 13 are opposed. Further, to the electric contact parts 53 at the four positions of a lower one side, lower seat parts 57 respectively formed in the terminals 13 are opposed.

Between the upper seat parts 55 and the electric contact parts 53 at the four positions of the rear one side, the semiconductor light emitting element 31 is mounted. Between the electric contact parts 53 at the four positions of the lower one side and the lower seat parts 57, the Zener diode 33 is mounted.

As shown in FIG. 5A, the semiconductor light emitting element 31 is the electronic devices 11 to be mounted on a surface which has the one pair of contact parts 27 provided on one surface. Further, as shown in FIG. 5B, the Zener diode 33 is also the electronic devices 11 to be mounted on a surface which has the one pair of contact parts 27 provided on one surface.

In the semiconductor light emitting element 31, as shown in FIG. 4C, the surface on which the contact parts 27 are provided is directed to the electric contact parts 53 in an upper stage and a back surface is allowed to abut on the upper seat parts 55. In the Zener diode 33, the surface on which the contact parts 27 are provided is directed to the electric contact parts 53 side of a lower stage and a back surface is allowed to abut on the lower seat parts 57. In the present embodiment, a pitch between contacts of the semiconductor light emitting element 31 is smaller than a pitch between contacts of the Zener diode 33. Namely, the two electronic devices 11 have different pitches between contacts. In the connecting structure of the electronic devices 11, the electronic devices 11 having the different pitches between the contacts as described above can be mounted at the same time. Namely, as shown in FIG. 4C, in one side, the one pair of contact parts 27 of the semiconductor light emitting element 31 come into contact with the adjacent electric contact parts 53 of the two terminals 13. In the other side, the electric contact parts 53 of the two terminals 13 come into contact with the one pair of contact parts 27 of the Zener diode 33 by striding over at least one electric contact part 53.

As shown in FIG. 4C, the semiconductor light emitting element 31 is connected to the second electric contact part 53 from a left side and the third electric contact part 53 from the left side in the electric contact parts 53 of the upper stage. Further, the Zener diode 33 is connected to the first electric contact part 53 from the left side and the third electric contact part 53 from the left side in the electric contact parts 53 of the lower stage, however, the Zener diode 33 may be connected to the second electric contact part 53 from the left side and the fourth electric contact part 53 from the left side. Further, in the present embodiment, the Zener diode 33 is used in which the pitch between the contacts has a distance two times as large as a pitch between contacts of the electric contact part 53, however, the Zener diode may be used in which the pitch between the contacts has a distance three times as large as the pitch between the contacts of the electric contact part 53. In this case, the one pair of contact parts 27 of the Zener diode 33 are connected to the first electric contact part 53 from the left side and the fourth electric contact part 53 from the left side.

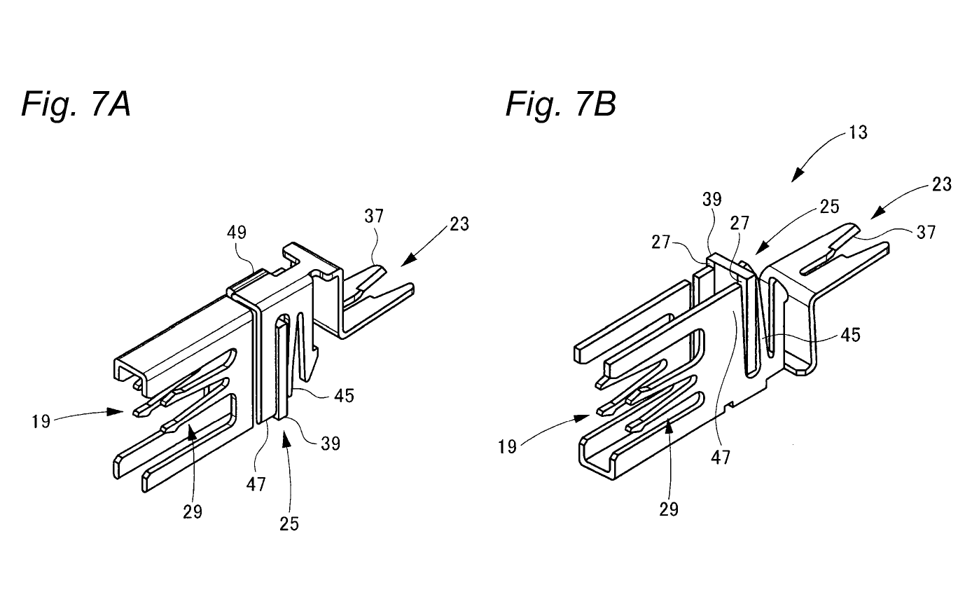

FIG. 6 is a circuit diagram in the connecting structure shown in FIG. 1. FIG. 7A is a perspective view of the terminal 13 having a connecting portion 49 separated and FIG. 7B is a perspective view in which an upper part and a lower part of FIG. 7A are inverted.

In the connecting structure of the electronic devices 11, the semiconductor light emitting element 31 and the Zener diode 33 are connected in parallel between an anode 59 and a cathode 61. In such a connecting structure of the electronic devices 11, a circuit is supposed to have the resistor 39 provided between the semiconductor element 31 and the Zener diode 33 and the anode 59. In such a case, in the third press contact part 25 of this structure, as shown in FIG. 7A, during a connection of the resistor 39, the connecting portion 49 is separated between one pair of auxiliary contact spring pieces 45 which are respectively connected to one pair of contact parts 27 of the resistor 39.

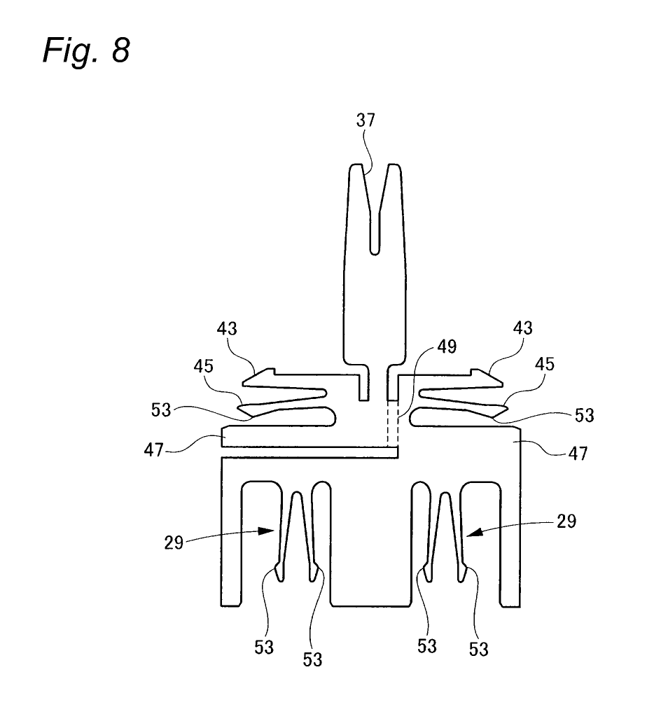

FIG. 8 is a development view of the terminal 13.

The terminal 13 is obtained by bending a metal plate of a developed form shown in FIG. 8 so as to have the form shown in FIG. 3. Since the connecting portion 49 is a part that connects the one pair of auxiliary contact spring pieces 45 together as shown in FIG. 8, when this portion is cut, the one pair of auxiliary contact spring pieces 45 are separated. Accordingly, when one auxiliary contact spring piece 45 of the one terminal 13 is connected in series to the other auxiliary contact spring piece 45 through the resistor 39, the second press contact part 23 in the one terminal 13 is connected in series to the first press contact part 19 through the resistor 39.

The resistor 39 is the electronic devices 11 to be mounted on a surface that has the two contact parts 27 on one surface. Thus, the connecting structure of the electronic devices 11 can be compactly formed which can allow the resistor 39 selectively to be mounted or not to be mounted.

Now, an attaching process of the connecting structure of the electronic devices 11 having the above-described structure will be described below.

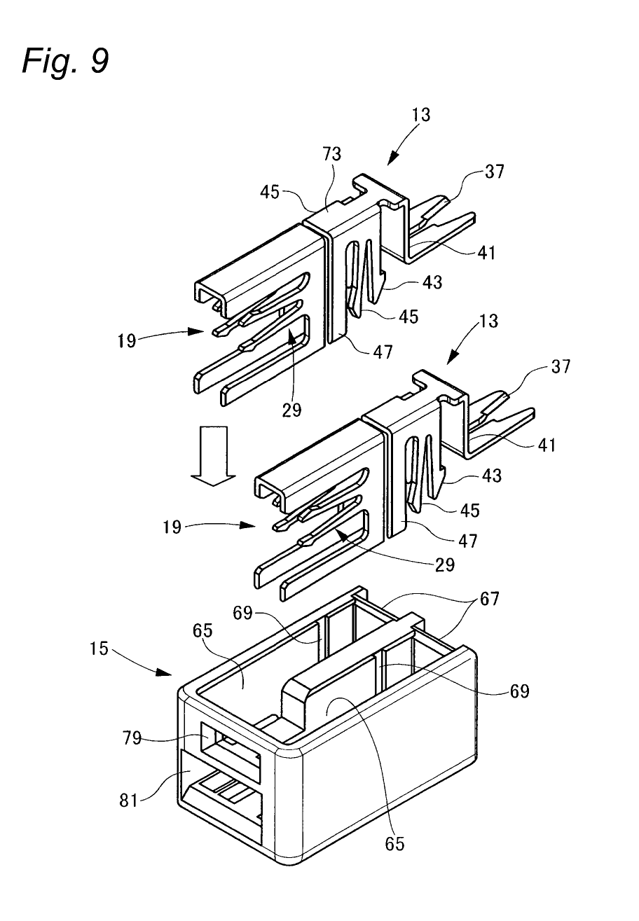

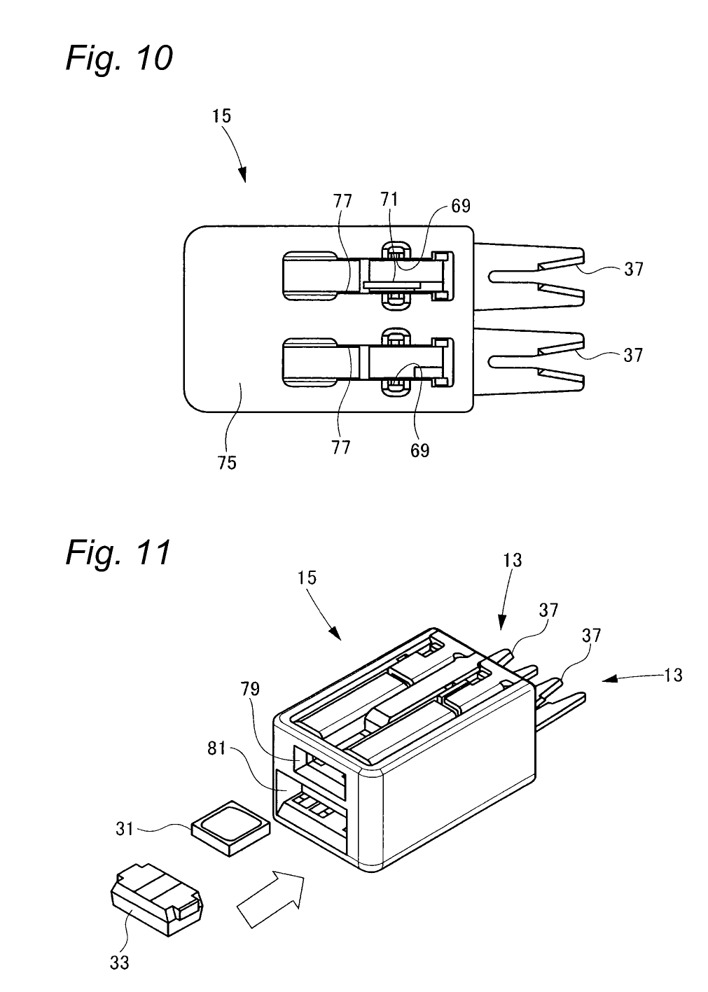

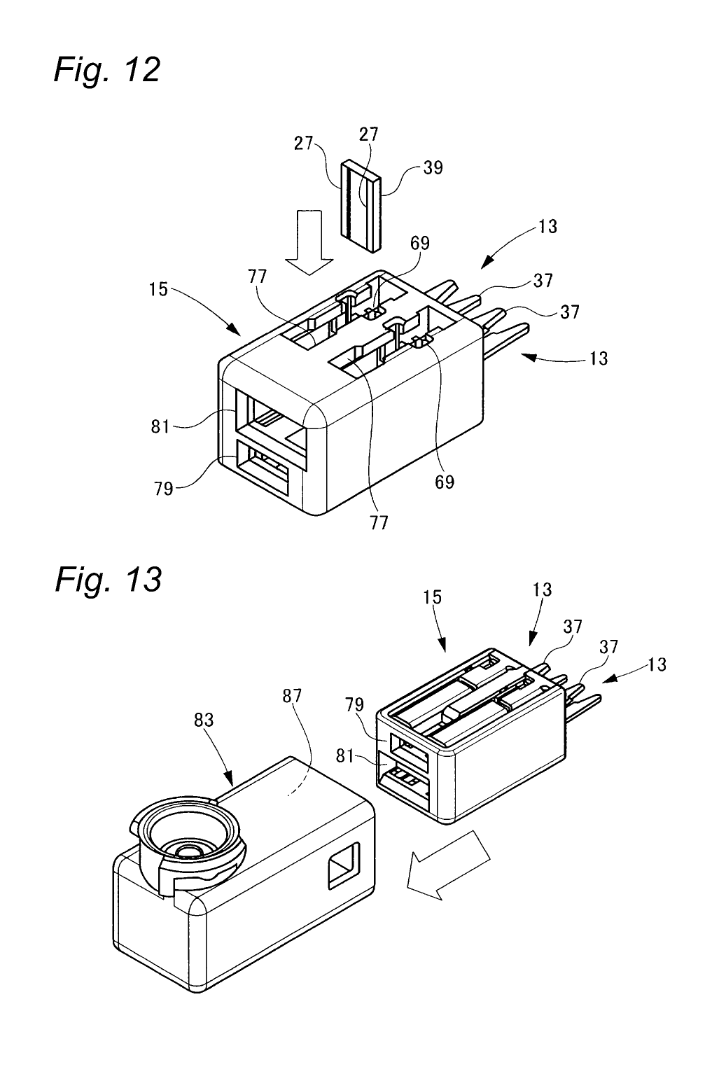

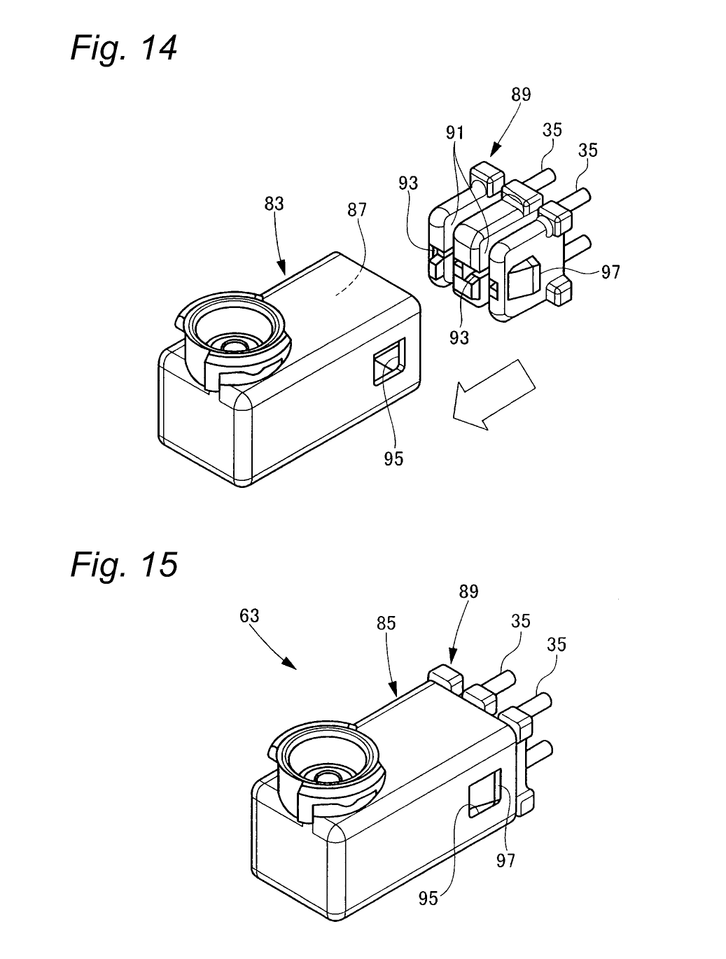

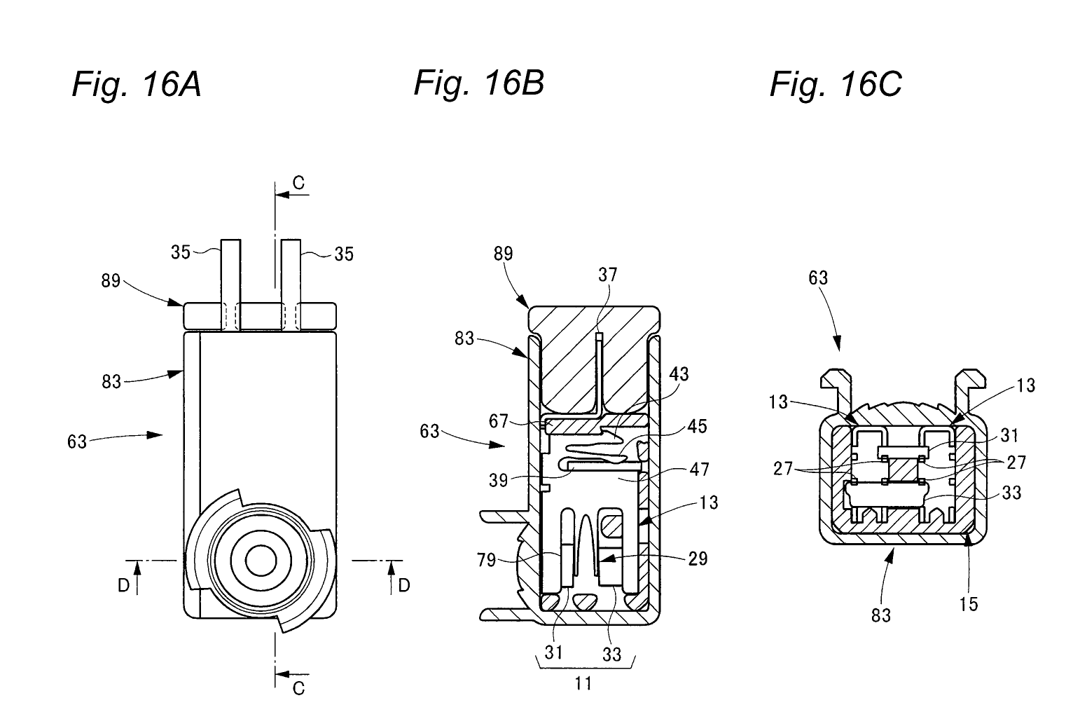

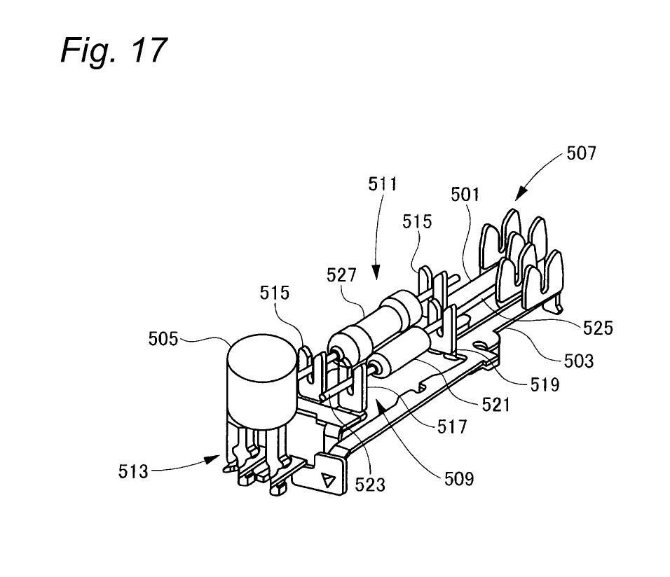

FIG. 9 is an attaching process diagram of the terminal. FIG. 10 is a cutting process diagram of the connecting portion 49. FIG. 11 is an attaching process diagram of the electronic devices. FIG. 12 is an attaching process diagram of the resistor 39. FIG. 13 is an attaching process diagram of the housing. FIG. 14 is an attaching process diagram of an electric wire holder. FIG. 15 is a perspective view of an LED unit 63. FIG. 16A is a plan view of the LED unit 63, FIG. 16B is a view seen from a line C-C thereof and FIG. 16C is a view seen from a line D-D thereof.

The above-described connecting structure of the electronic devices 11 can be preferably used in, for instance, the LED unit 63. When the connecting structure of the electronic devices 11 is applied to the LED unit 63, as shown in FIG. 9, the two terminals 13 are attached to the housing 15.

In the housing 15, two terminal accommodating chambers 65 are formed. The terminal accommodating chambers 65 have rear ends as rear walls 67. On inner wall surfaces of front parts of the rear walls 67, one pair of holding grooves 69 are respectively formed in the terminal accommodating chambers 65. The terminal 13 inserted into the terminal accommodating chamber 65 holds the rear wall 67 between the rear part abutting piece 41 and the rear part resilient leg 43 to restrain the terminal from slipping out from the housing 15 and complete the attachment of the terminal 13.

When the terminals 13 are attached to the housing 15, the connecting portion 49 of the one terminal 13 is cut. The terminal 13 inserted into the terminal accommodating chamber 65 has the connecting portion 49 located in a front surface 73 in an inserting direction. In other words, the connecting portion 49 is disposed on a surface of the terminal 13 facing in a direction opposite to an inserting direction of the terminal 13. Thus, whether or not the connecting portion 49 is cut in a cut area 71 can be easily recognized by visually recognizing the front surface 73 in the inserting direction from an inserting side of the terminal accommodating chamber 65. Further, as shown in FIG. 10, on a bottom plate 75 of the housing 15, bottom plate opening parts 77 are formed for attaching the resistor 39. On the bottom plate opening parts 77 respectively, the pair of holding grooves 69 are provided. Namely, the terminal 13 is inserted from an upper side of the housing 15 and the resistor 39 is inserted from a lower side of the housing 15.

As shown in FIG. 11, on a front surface of the housing 15, an LED attaching opening part 79 and a diode attaching opening part 81 are formed in two upper and lower stages. Into the LED attaching opening part 79, the semiconductor light emitting element 31 is inserted with the contact parts 27 directed downward. Into the diode attaching opening part 81, the Zener diode 33 is inserted with the contact parts 27 directed upward. Thus, as shown in FIG. 4C, the contact parts 27 are respectively connected to the electric contact parts 53.

As shown in FIG. 12, after the semiconductor light emitting element 31 and the Zener diode 33, the resistor 39 is inserted. The resistor 39 is inserted with both edge parts guided by the holding grooves 69 from the bottom plate opening part 77, so that the contact parts 27 are respectively connected to the one pair of auxiliary contact spring pieces 45.

As shown in FIG. 13, the housing 15 to which the semiconductor light emitting element 31 and the Zener diode 33 are attached is attached to a lens cover 83. On a rear end surface of the lens cover 83, a housing inserting opening 87 is formed. The housing 15 inserted into the lens cover 83 has the press contact blades 37 protruding rearward in the lens cover 83.

As shown in FIG. 14, into the lens cover 83 to which the housing 15 is attached, an electric wire holder 89 is inserted from the housing inserting opening 87. In three outer surfaces of the electric wire holder 89, U shaped electric wire holding grooves 91 are formed at two positions. To the electric wire holding grooves 91, the coated electric wires 35 are respectively bent in the shapes of U and attached. On a front surface of the electric wire holder 89, horizontal press contact blade entering slits 93 are formed which respectively extend over the electric wire holding grooves 91. Thus, when the electric wire holder 89 is inserted into the lens cover 83, the press contact blades 37 protruding rearward in the lens cover 83 enter the press contact blade entering slits 93 to connect the press contact blades 37 to the conductors of the electric wires 35.

In the electric wire holder 89 inserted into the lens cover 83, an engaging pawl 97 protruding in a side surface is engaged with an engaging hole 95 formed in a side part of the lens cover 83 to regulate the disengagement of the housing 15 and the electric wire holder itself from the lens cover 83. When the housing 15 and the electric wire holder 89 are attached to the lens cover 83, an LED unit 63 shown in FIG. 15 is formed.

As described above, in the connecting structure of the electronic devices 11, as shown in FIG. 16, the two terminals 13 having the one pair of main contact spring pieces 29 arranged to be opposed to each other are spaced from each other and arranged in parallel. Between the two terminals, the one pair of contact parts 27 of the semiconductor light emitting element 31 are connected to the one pair of adjacent main contact spring pieces 29. Further, the other pair of main contact spring pieces 29 located between the two terminals are connected to the one pair of contact parts 27 of the Zener diode 33. Thus, the electronic devices 11 having the different pitches between the contacts can be connected together.

Since the two terminals 13 having the one pair of parallel main contact spring pieces 29 which branch substantially in the shapes of Y are spaced from each other and arranged in parallel, the electric contact parts 53 provided at four positions in one side are arranged at eight positions in both sides. Thus, to the electric contact parts 53 of the two terminals 13 adjacent in one side, the semiconductor light emitting element 31 having the small pitch between the contacts can be connected. In the other side, to the electric contact parts 53 of the two terminals 13, the Zener diode 33 having the large pitch between the contacts can be connected by striding over at least one electric contact part 53.

In addition thereto, when the resistor 39 is not connected in series to the one terminal 13, the connecting portion 49 of the one terminal 13 is not cut and used. When the resistor 39 is connected in series to the terminal 13, since the connecting portion 49 of the one terminal 13 is cut as shown in FIG. 10, the one kind of terminal 13 can meet the presence or absence of attachment of the resistor 39.

In the connecting structure of the electronic devices 11 according to the present embodiment, the electronic devices 11 to be mounted on a surface which have the different pitches between the contacts can be connected together by using the one kind of terminal 13. Further, the number of kinds of terminals can be set to the one kind of terminal 13 irrespective of the presence or absence of the electronic devices 11.

According to the connecting structure of the electronic devices, the two terminals having the one pair of main contact spring pieces arranged to be opposed to each other are spaced from each other and arranged in parallel. Between the two terminals, the one pair of contact parts of the first electronic devices are connected to the one pair of adjacent main contact spring pieces. Further, the other pair of main contact spring pieces located between the two terminals are connected to the one pair of contact parts of the second electronic devices. Thus, the electronic devices having different pitches between contacts can be connected together.

In addition thereto, when other electronic devices is not connected in series to the one terminal, the connecting portion of the one terminal is not cut and used. When other electronic devices is connected in series to the terminal, since the connecting portion of the one terminal is cut, the one kind of terminal can meet the presence or absence of attachment of other electronic devices.

According to the connecting structure of the electronic devices, when the connecting part of the one terminal is separated, the one pair of auxiliary contact spring pieces are separated from each other in the third press contact part of the one terminal. Accordingly, the one separated auxiliary contact spring piece is connected to the second press contact part and the other auxiliary contact spring piece is connected to the first press contact part. When the one pair of separated auxiliary contact spring pieces are connected in series through the resistor, the second press contact part is connected in series to the first press contact part through the resistor.

According to the connecting structure of electronic devices, whether or not the connecting portion is cut can be easily recognized by visually recognizing the front surface in the inserting direction from an inserting side of the terminal accommodating chamber.

According to the connecting structure of electronic devices, the connecting structure of the electronic devices can be compactly formed which can allow other electronic devices selectively to be mounted or not to be mounted.

The present application is based on Japanese Patent Application No. 2010-258230 filed on Nov. 18, 2010, the contents of which are incorporated herein by way of reference.

The present invention is extremely useful in providing the connecting structure for the electronic devices in which just one kind of the terminal is necessary for the electronic devices to be mounted on a surface which have different pitches between contacts and irrespective of the presence or absence of the electronic devices.

What is claimed is:

1. A connecting structure for electronic devices, the connecting structure comprising:
a terminal, including:
a first contact part, provided at one end portion of the terminal, and having a main contact piece, the main contact piece being configured to come in resilient contact with a contact of a first electronic device;
a second contact part, provided at the other end portion of the terminal, and configured to come in press contact with an electric wire; and
a third contact part, provided between the first contact part and the second contact part, having a pair of auxiliary contact pieces configured to respectively come in press contact with a pair of contacts of a second electronic device, and formed with a connecting portion which connects the pair of the auxiliary contact pieces each other in a separatable manner.

2. The connecting structure as set forth in claim 1, comprising a pair of the terminals, wherein
one of the terminal is connected to an anode,
the other of the terminal is connected to a cathode, and
the connecting portion is separated thereby the pair of the auxiliary contact pieces are series-connected with each other through the second electronic device.

3. The connecting structure as set forth in claim 1, wherein
in a state where the terminal is inserted into a housing, the connecting portion is disposed on a surface of the terminal facing in a direction opposite to an inserting direction of the terminal.

4. The connecting structure as set forth in claim 1, wherein
the pair of contacts of the second electronic device are provided on a same surface of the second electronic device.
